(19) United States
(12) Patent Application Publication
(10) Pub. No.: US 2025/0209871 A1
(43) Pub. Date: Jun. 26, 2025

(54) INTEGRATED LOAD CONDITION MONITORING FOR A WORK VEHICLE

(71) Applicant: CNH Industrial America LLC, New Holland, PA (US)

(72) Inventors: Nathaniel James Keller, Harwood, ND (US); Alexander Schmeling, West Fargo, ND (US); Todd W. Evensen, Fargo, ND (US)

(21) Appl. No.: 18/391,904

(22) Filed: Dec. 21, 2023

(51) Int. Cl. G07C 5/08; E02F 9/26; G07C 5/00

(52) U.S. Cl. CPC G07C 5/0816; E02F 9/26; G07C 5/008

(57) ABSTRACT

Techniques of integrated load condition monitoring for a work vehicle. The work vehicle includes a boom coupled between a work implement and a chassis of the work vehicle. The work vehicle also includes a sensor network configured to monitor a payload supported by the work implement. The sensor network includes a tire pressure sensor configured to monitor air pressure within a tire of the work vehicle. The work vehicle further includes a controller communicatively coupled to the sensor network. The controller is configured to determine a force acting on a structural component of the work vehicle based on air pressure within the tire.

### BACKGROUND

The present disclosure relates generally to a work vehicle and, more particularly, to integrated load condition monitoring for a work vehicle.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A work implement coupled to a work vehicle may interact with a load during operation. Interaction between the work implement and the load may apply or exert various forces on structural components of the work vehicle. Stress generally occurs in a structural component of a work vehicle when such force is applied to the structural component, as does strain proportional to the stress. Differences between load conditions and a rated operating load of a work vehicle can impact how structural components of the work vehicle react to forces applied by the load conditions. For example, forces applied by load conditions that exceed a rated operating load of a work vehicle may adversely affect structural components of the work vehicle. Such adverse effects may reduce the longevity of the structural components. Such adverse effects may also reduce availability of the work vehicle to perform work.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a work vehicle includes a boom coupled between a work implement and a chassis of the work vehicle. The work vehicle also includes a sensor network configured to monitor a payload supported by the work implement. The sensor network includes a tire pressure sensor configured to monitor air pressure within a tire of the work vehicle. The work vehicle further includes a controller communicatively coupled to the sensor network. The controller is configured to determine a force acting on a structural component of the work vehicle based on air pressure within the tire.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a perspective view of an example work vehicle, in accordance with aspects of the disclosure;

FIG. 2 is a schematic block diagram of the work vehicle in FIG. 1, in accordance with aspects of the present disclosure;

FIGS. 3A-3G are block diagrams illustrating various forces acting on the work vehicle of FIG. 1, in accordance with aspects of the present disclosure; and

FIG. 4 is a flow chart of a method of integrated load condition monitoring for a work vehicle, in accordance with aspects of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments.

Use of the terms “approximately,” “near,” “about,” “close to,” “proximate to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

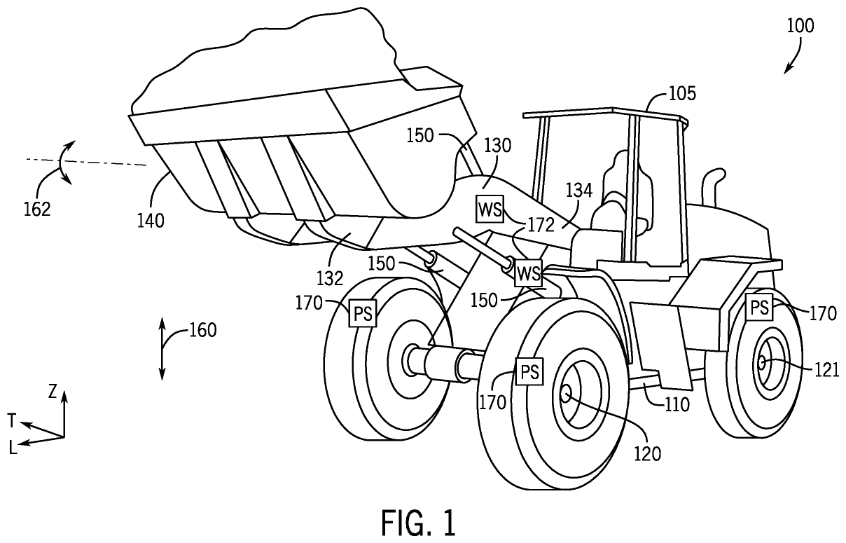

FIG. 1 is a perspective view of an example work vehicle 100, in accordance with aspects of the present disclosure. The work vehicle 100 includes an occupant portion or section, shown as a cab 105, supported by a chassis 110. The cab 105 may be offset from the chassis 110 in a vertical direction Z. The chassis 110 may be positioned between a front axle 120 and a rear axle 121. The front axle 120 may precede the rear axle 121 in a longitudinal direction L. The front axle 120 is coupled between a front-left tire and a front-right tire that is offset from the front-left tire in a transverse direction T. The front-left tire and the front-right tire may be coupled to the rear axle 121 via a front-left wheel and a front-right wheel, respectively. The front-left tire and the front-right tire coupled to the front axle 120 may be referred to as a front pair of tires. The rear axle 121 is coupled between a rear-left tire and a rear-right tire (not shown) that is offset from the rear-left tire in the transverse direction T. The rear-left tire and the rear-right tire may be coupled to the rear axle 121 via a rear-left wheel and a rear-right wheel, respectively. The rear-left tire and the rear-right tire coupled to the rear axle 121 may be referred to as a rear pair of tires. The work vehicle 100 also includes a boom 130 with a fore end 132 and an aft end 134 that is offset from the fore end 132 in a direction opposing the longitudinal direction L. The fore end 132 of the boom 130 is configured to be coupled to a work implement 140 to perform tasks. In FIG. 1, the fore end 132 of the boom 130 is pivotally coupled to the work implement 140. The aft end 134 of the boom 130 is pivotally coupled to the chassis 110.

The work vehicle 100 also includes one or more actuators 150 coupled to the boom 130. The one or more actuators 150 are configured to drive movement of the work implement 140 with respect to a driving surface underlying the work vehicle 100. For example, the one or more actuators 150 may be configured to drive pivotal movement of the boom 130 relative to the chassis 110 while the aft end 134 remains pivotally coupled to the chassis 110. By causing such pivotal movement of the boom 130, the one or more actuators 150 may drive vertical movement (e.g., raising and/or lowering) of the work implement 140 relative to the driving surface, as indicated by bi-directional arrows 160. As another example, the one or more actuators 150 may drive pivotal movement of the work implement 140 relative to the boom 130 while the fore end 132 remains pivotally coupled to the work implement 140. By driving such pivotal movement of the work implement 140, the one or more actuators 150 may drive rotational movement (e.g., curling and/or dumping) of the work implement 140 relative to the driving surface, as indicated by bi-directional arrows 162.

The work vehicle 100 also includes a number of different sensors that are each generally configured to monitor a given physical parameter during operation of the work vehicle 100 and output data or a signal indicative of the given physical parameter. As a given physical parameter changes, the data or signal indicative of the given physical parameter varies (e.g., in proportion) with such changes. The different sensors of the work vehicle 100 may include a number of tire pressure sensors 170. Each tire pressure sensor 170 is in fluid communication with the air inside a given tire of the work vehicle 100 and is configured to detect changes in air pressure within the given tire. The different sensors of the work vehicle 100 may also include a number of weight sensors 172 configured to monitor a load on the boom 130, the one or more actuators 150, or both. Each weight sensor 172 is configured to detect changes in weight applied at the fore end 132 of the boom 130. The weight applied at the fore end 132 of the boom 130 may be referred to as a payload of the work vehicle 100 for convenience. In certain embodiments, the payload of the work vehicle 100 may include a weight of the work implement 140 coupled to the fore end 132 of the boom 130 and/or a weight of material that is introduced into a volume of the work implement or otherwise carried by the work implement.

In operation, the work vehicle 100 is generally configured to perform various tasks, such as loading, lifting, pushing, rotating, dozing, and other tasks. The work vehicle 100 may be coupled to different work implements to perform different tasks. For example, in the illustrated embodiment, the work implement 140 includes a bucket configured to perform a loading task. Coupling the work implement 140 to the work vehicle 100 may increase a payload of the work vehicle 100 by a weight of the work implement 140. The loading task may involve introducing material (e.g., soil, sand, rocks, etc.) into a volume of the work implement 140. Introducing the material into the volume of the work implement 140 may increase the payload of the work vehicle 100 by a weight of the material.

Differences between a payload of the work vehicle 100 and a rated operating load of the work vehicle 100 can impact how structural components of the work vehicle 100 react to forces applied by the payload. For example, forces applied by a payload that exceeds the rated operating load of the work vehicle 100 may adversely affect structural components of the work vehicle 100 (e.g., by causing excess fatigue). Forces applied to structural components of the work vehicle 100 by a payload of the work vehicle 100 may vary with respect to both magnitude and direction of application. Example structural components of the work vehicle 100 include: the chassis 110, the front axle 120, the rear axle 121, the boom 130, the one or more actuators 150, and other structural components of the work vehicle 100.

In FIG. 1, the work vehicle 100 and the work implement 140 are depicted as a wheel loader and a bucket, respectively. In some embodiments, the work vehicle 100 may be another construction machine or vehicle such as a skid steer loader, an excavator, a backhoe loader, a bulldozer, a telchandler, a motor grader, and/or another type of construction machine or vehicle. In some embodiments, the work vehicle 100 may be an agricultural machine or vehicle such as a tractor, a telehandler, a front loader, a combine harvester, a grape harvester, a forage harvester, a sprayer vehicle, a windrower, and/or another type of agricultural machine or vehicle. In some embodiments, the work implement 140 may be another work implement, such as a dozer blade, a grapple, a fork, a claw, a broom, a snowplow, and the like.

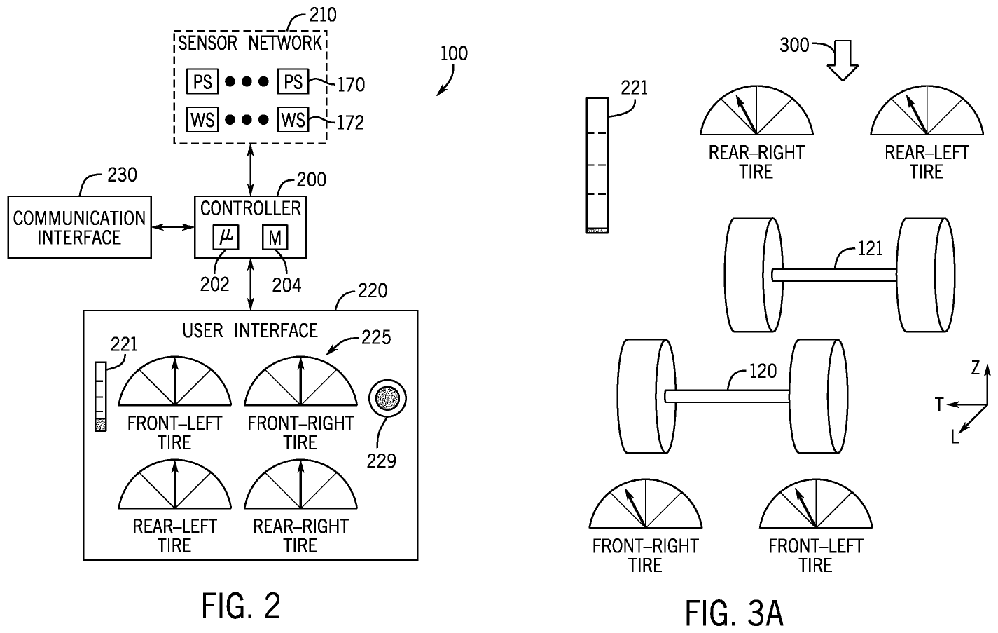

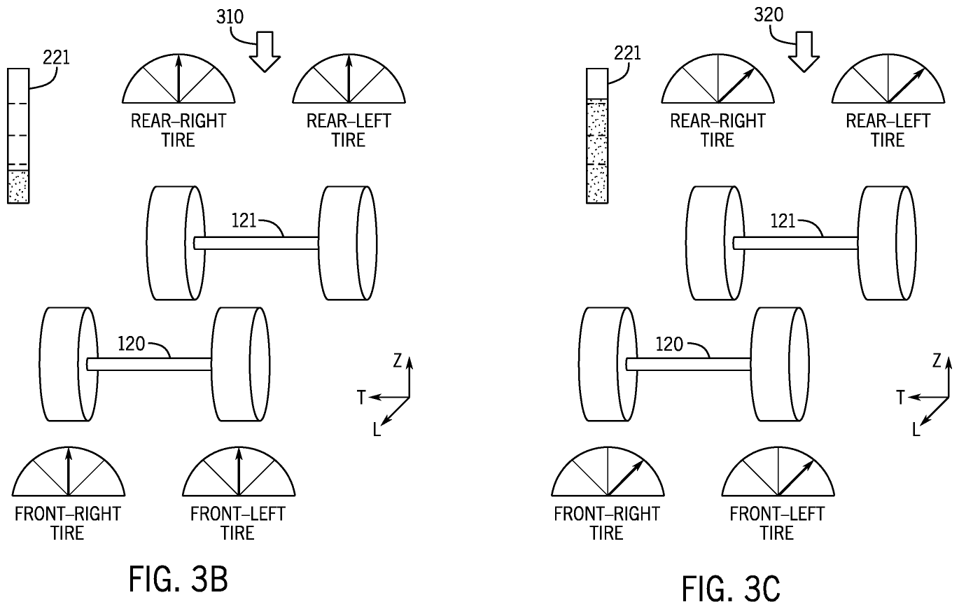

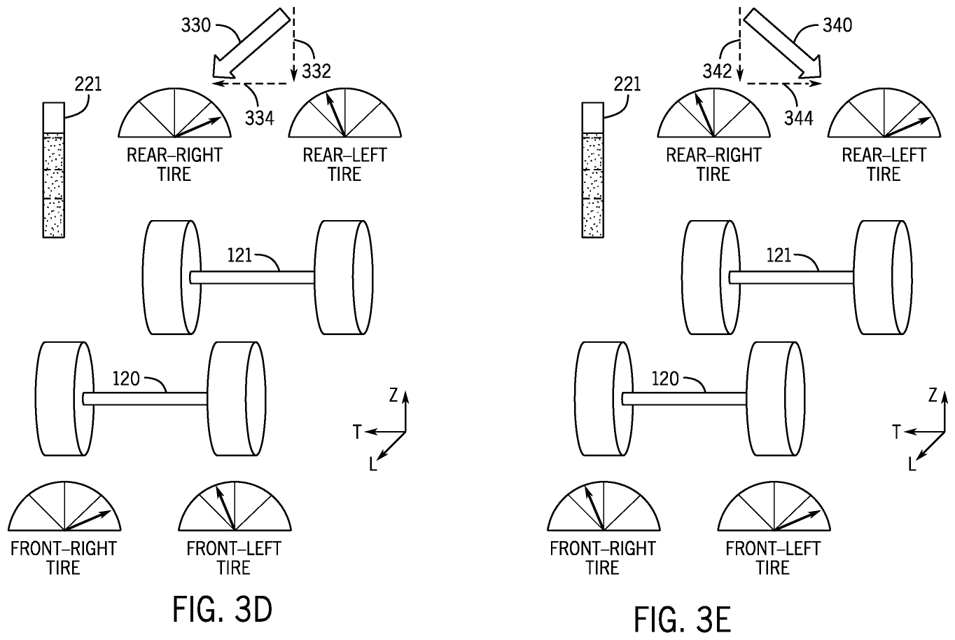

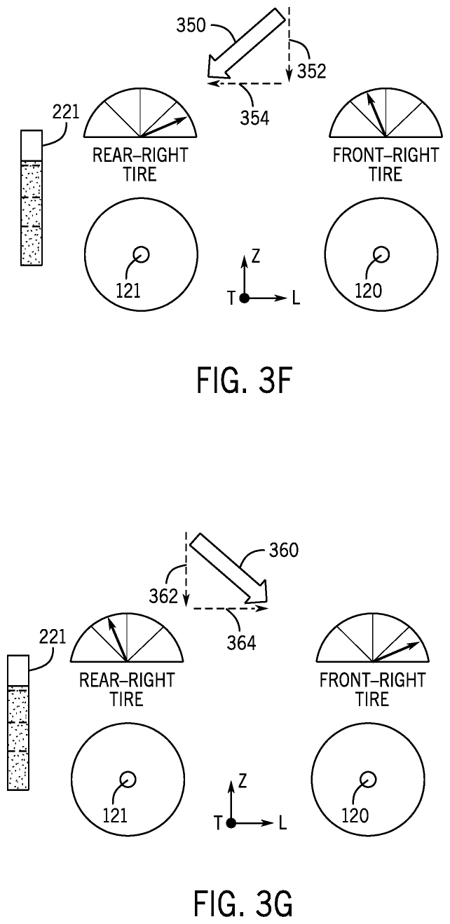

FIG. 2 is a schematic block diagram of the work vehicle 100 in FIG. 1, in accordance with aspects of the present disclosure. With reference to FIG. 2, the work vehicle 100 also includes a controller 200 that may be configured to implement the techniques described herein. The controller 200 includes a processor 202 and memory 204. In certain embodiments, the processor 202 may include one or more general purpose processors, one or more application specific integrated circuits, one or more field programmable gate arrays, or the like. The memory 204 may include volatile memory, such as random-access memory (RAM) and/or nonvolatile memory such as read-only memory (ROM). The memory 204 may also be any tangible, non-transitory, computer readable medium that is capable of storing instructions executable by the processor 202 and/or data that may be processed by the processor 202. In the illustrated embodiment, the controller 200 is communicatively coupled to a sensor network 210, a user interface 220, and a communication interface 230. The sensor network 210 may include different sensors of the work vehicle 100, such as the one or more tire pressure sensors 170 and the one or more weight sensors 172. The sensor network 210 may be configured to monitor operating parameters of the work vehicle 100. For example, the sensor network 210 may be configured to monitor a payload of the work vehicle 100 while performing tasks such as the loading task described below with reference to FIGS. 3A-3G. The user interface 220 may include a payload indicator 221, one or more tire pressure indicators 225, and an alert indicator 229. The one or more tire pressure indicators 255 may include a tire pressure indicator for each tire of the work vehicle 100, such as a front-left tire pressure indicator for the front-left tire, a front-right tire pressure indicator for the front-right tire, a rear-left tire pressure indicator for the rear-left tire, and a rear-right tire pressure indicator for the rear-right tire.

The controller 200 is configured to monitor operating parameters such as a payload of the work vehicle 100 using data received from the sensor network 210. For example, the controller 200 may be configured to monitor air pressure within one or more tires of the work vehicle 100 using data received from the corresponding tire pressure sensor(s) 170. As another example, the controller 200 may monitor a weight carried by the boom 130, such as a weight of the work implement 140, using data received from the one or more weight sensors 172. In certain embodiments, the controller 200 may be configured to store data received from the sensor network 210 and/or metadata associated with the data from the sensor network 210 in the memory 204. Examples of metadata may include a timestamp associated with the data received from the sensor network 210, positional data correlating the data received from the sensor network 210 to particular locations of the work vehicle 100, sampling intervals, a type of sensor providing the data received from the sensor network 210, and the like.

The controller 200 may also be configured to cause the user interface 220 to display values of various operating parameters of the work vehicle 100. For example, the controller 200 may be configured to cause the payload indicator 221 to display a current payload of the work vehicle 100, such as a weight carried by the boom 130 (e.g., a weight of the work implement 140 coupled to the boom 130). As another example, the controller 200 may be configured to cause the front-left tire pressure indicator, the front-right tire pressure indicator, the rear-left tire pressure indicator, and the rear-right tire pressure indicator to display air pressure within the front-left tire, the front-right tire, the rear-left tire, and the rear-right tire, respectively. In some embodiments, the work vehicle 100 may include more (e.g., 5) or fewer (e.g., 3) tires. In such embodiments, the user interface 200 may include a number of tire pressure indicators that corresponds to the number of tires. As another example, the controller 200 may be configured to cause the alert indicator 229 to illuminate responsive to determining that an operating parameter of the work vehicle 100 exceeds a threshold or falls outside a desired range, such as responsive to detecting that the work vehicle 100 is in an overload state.

The controller 200 may further be configured to determine forces acting on one or more structural components of the work vehicle 100 by monitoring a payload of the work vehicle 100 while performing tasks. In certain embodiments, the controller 200 may be configured to determine such forces using mathematical models and/or lookup tables stored in the memory 204. In certain embodiments, the controller 200 may use the mathematical models and/or lookup tables stored in the memory 204 to determine forces acting on one or more structural components of the work vehicle 100 as a function of a payload of the work vehicle 100. In certain embodiments, the mathematical models and/or lookup tables stored in the memory 204 may map or correlate operating parameters (e.g., a weight carried by the boom 130 and/or air pressure within the front-left tire, the front-right tire, the rear-left tire, and/or the rear-right tire) indicative of the payload with associated forces acting on one or more structural components of the work vehicle 100. For example, the controller 200 may be configured to determine a force acting on one or more structural components of the work vehicle 100 based on a weight carried by the boom 130 and air pressure within, at least, one tire (e.g., the air pressure within one or more of the front pair of tires, the air pressure within one or more of the rear pair of tires, and/or the air pressures within all of the tires of the work vehicle 100). In this example, the controller 200 may provide data received from one or more of the tire pressure sensors 170 and/or one or more of the weight sensors 172 as input to the mathematical models and/or lookup tables stored in the memory 204. In this example, the mathematical models and/or lookup tables stored in the memory 204 may output associated forces acting on one or more structural components of the work vehicle 100 responsive to that input. In certain embodiments, the mathematical models and/or lookup tables stored in the memory 204 may also translate a force acting on one structural component (e.g., the front axle 120) of the work vehicle 100 to a force acting on another structural component (e.g., the rear axle 121) of the work vehicle 100.

In certain embodiments, the mathematical models and/or lookup tables stored in the memory 204 may output associated forces acting on one or more structural components of the work vehicle 100 in terms of magnitude and/or direction (e.g., as a vector quantity). For example, the controller 200 may provide data received from one or more of the tire pressure sensors 170 and/or one or more of the weight sensors 172 as input to the mathematical models and/or lookup tables stored in the memory 204. In this example, the mathematical models and/or lookup tables stored in the memory 204 may output magnitudes of associated forces acting on one or more structural components of the work vehicle 100 responsive to that input. As another example, the controller 200 may provide data received from one or more of the tire pressure sensors 170 as input to the mathematical models and/or lookup tables stored in the memory 204. In this example, the mathematical models and/or lookup tables stored in the memory 204 may output magnitudes and directions of associated forces acting on one or more structural components of the work vehicle 100 responsive to that input.

In certain embodiments, the controller 200 may use the determined forces acting on the one or more structural components of the work vehicle 100 to detect whether the work vehicle 100 is in an overload state. For example, the controller 200 may detect that the work vehicle 100 is in an overload state when a magnitude and/or direction of a force acting on a structural component of the work vehicle 100 indicates that a payload of the work vehicle 100 exceeds a rated operating load of the work vehicle 100. In certain embodiments, the controller 200 may output a notification to a remote computing device using the communication interface 230 when the payload of the work vehicle 100 exceeds a rated operating load of the work vehicle 100.

In certain embodiments, the controller 200 may use the determined forces acting on the one or more structural components of the work vehicle 100 to estimate a current physical condition of a structural component of the work vehicle 100. In certain embodiments, the controller 200 may consider reference data stored in the memory 204 when estimating the current physical condition of the structural component. The reference data may be associated with physical condition(s) of the one or more structural components of the work vehicle 100. The reference data may include reliability data (e.g., an expected service life or mean time between failure (MTBF) information) that characterizes physical conditions of the one or more structural components prior to being placed in-service. The reliability data may be determined by a manufacturer of the work vehicle 100 using design parameters, maintenance information, and/or repair information. The reference data may also include historical data associated with the one or more structural components previously received from the sensor network 210 while the work vehicle 100 performed tasks and/or historical force values determined using the historical data. In certain embodiments, the controller 200 may use the estimated current physical condition to estimate a remaining service life of the structural component of the work vehicle 100. In certain embodiments, the controller 200 may output vehicle state data such as telematics data to a remote computing device using the communication interface 230. The vehicle state data may include the estimated current physical condition of the structural component of the work vehicle 100.

FIGS. 3A-3G are block diagrams illustrating various forces acting on the work vehicle 100, in accordance with an embodiment of the present disclosure. The various forces illustrated in FIGS. 3A-3G may include forces applied by changing load conditions as the work vehicle 100 performs a loading task. The loading task may involve coupling the work implement 140 to the fore end 132 of the boom 130 to perform the loading task, introducing material (e.g., soil, sand, rocks, etc.) into a volume of the work implement 140 at a first location, and moving the material from the first location toward a second location different than the first location. The material introduced into the volume of the work implement 140 may be referred to as load material. In the embodiment of FIGS. 3A-3G, the various forces acting on the work vehicle 100 are described with reference to a center of mass of the work vehicle 100 for convenience not limitation. In other embodiments, various forces acting on the work vehicle 100 may be described using other reference points, such as a point (e.g., a midpoint) along the front axle 120, a point (e.g., an intersection point between the rear axle 121 and the rear-left wheel coupled to the rear-left tire) along the rear axle 121, a pivot point at the aft end 134 of the boom 130, and/or other reference points.

FIG. 3A illustrates a force (represented in FIG. 3A by arrow 300) being applied downwardly toward the center of mass of the work vehicle 100, such as in a direction of the arrow 300 that opposes the vertical direction Z. In FIG. 3A, the force 300 may be applied by the weight of the boom 130 without any work implement coupled to the boom 130. The force 300 may represent a force acting on one or more structural components of the work vehicle 100 when the work vehicle 100 lacks a payload. FIG. 3A shows values of various operating parameters of the work vehicle 100 that the user interface 200 may display when the work vehicle 100 lacks a payload.

FIG. 3B illustrates a force (represented in FIG. 3B by arrow 310) being applied downward toward the center of mass of the work vehicle 100, such as in a direction of the arrow 310 that opposes the vertical direction Z. In FIG. 3B, the force 310 may be applied by the weight of the boom 130 and the weight of the work implement 140 coupled to the fore end 132 of the boom 130 to perform the loading task. A comparison between FIG. 3A and FIG. 3B shows that the magnitude of the force 310 is greater than the magnitude of the force 300. A magnitude difference between the magnitude of the force 310 and the magnitude of the force 300 may correspond to the weight of the work implement 140. In FIG. 3B, the payload indicator 221 may display a payload that includes the weight of the work implement 140. A difference between the payload indicator 221 in FIG. 3A and FIG. 3B may be representative of the weight of the work implement 140.

In FIG. 3B, the respective air pressure displayed by each tire pressure indicator of the user interface 200 may be greater than the corresponding air pressure displayed in FIG. 3A. In FIG. 3B, the collective weight of the boom 130 and the work implement 140 may be distributed equally or substantially equally among each tire. Accordingly, the respective air pressure displayed by each tire pressure indicator of the user interface in FIG. 3B may the same or substantially similar. A difference between a particular tire pressure indicator in FIG. 3A relative to FIG. 3B may relate to the magnitude difference between the magnitude of the force 310 and the magnitude of the force 300 that corresponds to the weight of the work implement 140. For example, the rear-left tire pressure indicator may display a first pressure value in FIG. 3A and a second pressure value in FIG. 3B that is greater than the first pressure value. In this example, a difference between the second pressure value and the first pressure value may be an increase in air pressure within the rear-left tire responsive to a payload increase corresponding to the weight of the work implement 140. Data provided by the tire pressure sensor corresponding to the rear-left tire may include that increase in air pressure within the rear-left tire.

FIG. 3C illustrates a force (represented in FIG. 3C by arrow 320) applied downwardly toward the center of mass of the work vehicle 100 such as in a direction of the arrow 320 that opposes the vertical direction Z. In FIG. 3C, the force 320 may be applied by the weight of the boom 130, the weight of the work implement 140, and the weight of the load material introduced into the volume of the work implement 140 at the first location. A comparison between FIG. 3B and FIG. 3C shows that the magnitude of the force 320 is greater than the magnitude of the force 310. A magnitude difference between the magnitude of the force 320 and the magnitude of the force 310 may correspond to the weight of the load material introduced into the volume of the work implement 140. In FIG. 3C, the payload indicator 221 may display a payload that includes the collective weight of the work implement 140 and the load material. The weight of the load material introduced into the volume of the work implement 140 may be referred to as load weight. A difference between the payload indicator 221 in FIG. 3B and FIG. 3C may be representative of the load weight.

In FIG. 3C, the respective air pressure displayed by each tire pressure indicator of the user interface may be greater than the corresponding air pressure displayed in FIG. 3B. In FIG. 3C, the load weight may be distributed equally or substantially equally among the tires. Accordingly, the air pressure displayed by each tire pressure indicator of the user interface in FIG. 3C may be the same or substantially similar. A difference between a particular tire pressure indicator in FIG. 3B relative to FIG. 3C may relate to the magnitude difference between the magnitude of the force 320 and the magnitude of the force 310 that corresponds to the load weight.

For example, the front-right tire pressure indicator may display a first air pressure in FIG. 3B and a second air pressure in FIG. 3C that is greater than the first air pressure. In this example, a difference between the second air pressure and the first air pressure may be an increase in air pressure within the front-right tire responsive to a payload increase corresponding to the load weight. Generally, each tire pressure indicator of the one or more tire pressure indicators 225 may also display greater air pressure in FIG. 3C than in FIG. 3B, as described above with reference to the front-right tire pressure indicator. Data provided by the front-right tire pressure sensor corresponding to the front-right tire may include that increase in air pressure within the front-right tire between FIG. 3B and FIG. 3C. A relationship may exist between that increase in air pressure within the front-right tire and the payload increase corresponding to the load weight. In certain embodiments, the mathematical models and/or lookup tables stored in the memory 204 may map or correlate air pressure increases within one or more tires of the work vehicle 100 with a corresponding payload (e.g., the load weight) of the work vehicle 100 based on such relationships. In certain embodiments, the controller 200 may be configured to determine or estimate a payload of the work vehicle 100 (e.g., the load weight) based on data received from the one or more tire pressure sensors. For example, the controller 200 may monitor air pressure in a single tire of the work vehicle 100 and use that to determine the payload of the work vehicle 100. As another example, the controller 200 may monitor air pressure in tires (e.g., the front pair of tires) coupled to an axle (e.g., the front axle 120) of the work vehicle 100 and use that to determine the payload of the work vehicle 100. As another example, the controller 200 may monitor air pressure in all tires of the work vehicle 100 and use that to determine the payload of the work vehicle 100.

While moving the load material from the first location toward the second location, the load material may redistribute unevenly within the volume of the work implement 140. For example, the work vehicle 100 may encounter uneven terrain while moving the load material from the first location toward the second location. FIGS. 3D-3G illustrate various forces acting on the work vehicle 100 while the load material is unevenly distributed within the volume of the work implement 140, in accordance with an embodiment of the present disclosure. In FIGS. 3D-3G, a bulk of the load material may have shifted within the work implement 140 in a particular direction (e.g., the transverse direction T) while a remainder of the load material, less than the bulk of the load material, may have shifted within the work implement 140 in other directions (e.g., a direction that opposes the transverse direction T, the longitudinal direction L, and/or a direction that opposes the longitudinal direction L). A comparison between FIG. 3C and any one of FIGS. 3D-3G shows that a payload (e.g., the collective weight of the work implement 140 and the load material) displayed by the payload indicator 221 may remain unchanged or substantially unchanged when the bulk of the load material shifts within the work implement 140 in a particular direction.

FIG. 3D illustrates a force (represented in FIG. 3D by arrow 330) acting on the work vehicle 100 when the bulk of the load material shifts rightward within the volume of the work implement 140 or in the transverse direction T. The force 330 includes a first component (represented in FIG. 3D by arrow 332) that may be applied downwardly toward the center of mass of the work vehicle 100, such as in a direction of the arrow 332 that opposes the vertical direction Z. The force 330 also includes a second component (represented in FIG. 3D by arrow 334) that may be applied offset from the center of mass of the work vehicle 100 in the transverse direction T (e.g., in a direction of the arrow 334). A comparison between FIG. 3C and FIG. 3D shows that the magnitude of the force 330 may be equal or substantially equal to the magnitude of the force 320. Accordingly, the payload displayed by the payload indicator 221 in FIG. 3C may be the same or substantially similar to the payload displayed by the payload indicator 221 in FIG. 3D.

A comparison between FIG. 3C and FIG. 3D also shows that the force 320 and the force 330 act on the work vehicle 100 in different directions. In FIG. 3C, the load weight was distributed equally or substantially equally among each tire of the work vehicle 100. In FIG. 3D, the load weight may be unequally distributed among the tires of the work vehicle 100. For example, the front-right tire and the rear-right tire may each carry a larger portion of the load weight in FIG. 3D than in FIG. 3C. The larger portion of the load weight carried by the front-right tire and/or the rear-right tire in FIG. 3D may relate to the second component 334 of the force 330. In FIG. 3D, the air pressure displayed by the front-right tire pressure indicator and the rear-right tire pressure indicator may be greater than the corresponding pressures displayed in FIG. 3C. A difference between the front-right tire pressure indicator in FIG. 3C and FIG. 3D may be representative of the larger portion of the load weight carried by the front-right tire in FIG. 3D than in FIG. 3C. A difference between the rear-right tire pressure indicator in FIG. 3C and FIG. 3D may be representative of the larger portion of the load weight carried by the rear-right tire in FIG. 3D than in FIG. 3C.

As another example, the front-left tire and the rear-left tire may each carry a smaller portion of the load weight in FIG. 3D than in FIG. 3C. The smaller portion of the load weight carried by the front-left tire and/or the rear-left tire in FIG. 3D may relate to the second component 334 of the force 330. In FIG. 3D, the respective air pressures displayed by the front-left tire pressure indicator and the rear-left tire pressure indicator may be lower than the corresponding air pressures displayed in FIG. 3C. A difference between the front-left tire pressure indicator in FIG. 3C and FIG. 3D may be representative of the smaller portion of the load weight carried by the front-left tire in FIG. 3D than in FIG. 3C. A difference between the rear-left tire pressure indicator in FIG. 3C and FIG. 3D may be representative of the smaller portion of the load weight carried by the rear-left tire in FIG. 3D than in FIG. 3C.

FIG. 3E illustrates a force (represented in FIG. 3E by arrow 340) acting on the work vehicle 100 when the bulk of the load material shifts leftward within the volume of the work implement 140 or in a direction that opposes the transverse direction T. The force 340 includes a first component (represented in FIG. 3E by arrow 342) that may be applied downwardly toward the center of mass of the work vehicle 100 such as in a direction of the arrow 342 that opposes the vertical direction Z. The force 340 also includes a second component (represented in FIG. 3E by arrow 344) that may be applied offset from the center of mass of the work vehicle 100 in a direction that opposes the transverse direction T, such as a direction of the arrow 344. A comparison between FIG. 3C and FIG. 3E shows that the magnitude of the force 340 may be equal or substantially equal to the magnitude of the force 320. Accordingly, the payload displayed by the payload indicator 221 in FIG. 3C may be the same or substantially similar to the payload displayed by the payload indicator 221 in FIG. 3E.

A comparison between FIG. 3C and FIG. 3E also shows that the force 320 and the force 340 act on the work vehicle 100 in different directions. In FIG. 3C, the load weight was distributed equally or substantially equally among each tire of the work vehicle 100. In FIG. 3E, the load weight may be unequally distributed among the tires of the work vehicle 100. For example, the front-left tire and the rear-left tire may each carry a larger portion of the load weight in FIG. 3E than in FIG. 3C. The larger portion of the load weight carried by the front-left tire and/or the rear-left tire in FIG. 3E may relate to the second component 344 of the force 340. In FIG. 3E, the respective air pressures displayed by the front-left tire pressure indicator and the rear-left tire pressure indicator may be greater than the corresponding air pressures displayed in FIG. 3C. A difference between the front-left tire pressure indicator in FIG. 3C and FIG. 3E may be representative of the larger portion of the load weight carried by the front-left tire in FIG. 3E than in FIG. 3C. A difference between the rear-left tire pressure indicator in FIG. 3C and FIG. 3E may be representative of the larger portion of the load weight carried by the rear-left tire in FIG. 3E than in FIG. 3C.

As another example, the front-right tire and the rear-right tire may each carry a smaller portion of the load weight in FIG. 3E than in FIG. 3C. The smaller portion of the load weight carried by the front-right tire and/or the rear-right tire in FIG. 3E may relate to the second component 344 of the force 340. In FIG. 3E, the respective air pressures displayed by the front-right tire pressure indicator and the rear-right tire pressure indicator may be lower than the corresponding air pressures displayed in FIG. 3C. A difference between the front-right tire pressure indicator in FIG. 3C and FIG. 3E may be representative of the smaller portion of the load weight carried by the front-right tire in FIG. 3E than in FIG. 3C. A difference between the rear-right tire pressure indicator in FIG. 3C and FIG. 3E may be representative of the smaller portion of the load weight carried by the rear-right tire in FIG. 3E than in FIG. 3C.

FIG. 3F illustrates a force (represented in FIG. 3F by arrow 350) acting on the work vehicle 100 when the bulk of the load material shifts rearward within the volume of the work implement 140 or in a direction that opposes the longitudinal direction L. The force 350 includes a first component (represented in FIG. 3F by arrow 352) that may be applied downwardly toward the center of mass of the work vehicle 100 such as in a direction of the arrow 352 that opposes the vertical direction Z. The force 350 also includes a second component (represented in FIG. 3F by arrow 354) that may be applied offset from the center of mass of the work vehicle 100 in a direction that opposes the longitudinal direction L (e.g., in a direction of the arrow 354). A comparison between FIG. 3C and FIG. 3F shows that the magnitude of the force 350 may be equal or substantially equal to the magnitude of the force 320. Accordingly, the payload displayed by the payload indicator 221 in FIG. 3C may be the same or substantially similar to the payload displayed by the payload indicator 221 in FIG. 3F.

A comparison between FIG. 3C and FIG. 3F also shows that the force 320 and the force 350 act on the work vehicle 100 in different directions. In FIG. 3C, the load weight was distributed equally or substantially equally among each tire of the work vehicle 100. In FIG. 3F, the load weight may be unequally distributed among the tires of the work vehicle 100. For example, the rear-left tire and the rear-right tire may each carry a larger portion of the load weight in FIG. 3F than in FIG. 3C. The larger portion of the load weight carried by the rear-left tire and/or the rear-right tire in FIG. 3F may relate to the second component 354 of the force 350. In FIG. 3F, the air pressure displayed by the rear-right tire pressure indicator may be greater than the corresponding air pressure displayed in FIG. 3C. A difference between the rear-right tire pressure indicator in FIG. 3C and FIG. 3F may be representative of the larger portion of the load weight carried by the rear-right tire in FIG. 3F than in FIG. 3C. Although not shown in FIG. 3F, the rear-left tire pressure indicator may display an air pressure in FIG. 3F that is the same or substantially similar to the air pressure displayed by the rear-right tire pressure indicator in FIG. 3F. In that instance, a difference between the rear-left tire pressure indicator in FIG. 3C and FIG. 3F may be representative of the larger portion of the load weight carried by the rear-left tire in FIG. 3F.

As another example, the front-left tire and the front-right tire may each carry a smaller portion of the load weight in FIG. 3F than in FIG. 3C. The smaller portion of the load weight carried by the front-left tire and/or the front-right tire in FIG. 3F may relate to the second component 354 of the force 350. In FIG. 3F, the air pressure displayed by the front-right tire pressure indicator may be lower than the corresponding air pressure displayed in FIG. 3C. A difference between the front-right tire pressure indicator in FIG. 3C and FIG. 3F may be representative of the smaller portion of the load weight carried by the front-right tire in FIG. 3F than in FIG. 3C. Although not shown in FIG. 3F, the front-left tire pressure indicator may display an air pressure in FIG. 3F that is the same or substantially similar to the air pressure displayed by the front-right tire pressure indicator in FIG. 3F. In that instance, a difference between the front-left tire pressure indicator in FIG. 3C and FIG. 3F may be representative of the smaller portion of the load weight carried by the front-left tire in FIG. 3F.

FIG. 3G illustrates a force (represented in FIG. 3G by arrow 360) acting on the work vehicle 100 when the bulk of the load material shifts forward within the volume of the work implement 140 or in the longitudinal direction L. The force 360 includes a first component (represented in FIG. 3G by arrow 362) that may be applied downwardly toward the center of mass of the work vehicle 100 such as in a direction of the arrow 362 that opposes the vertical direction Z. The force 360 also includes a second component (represented in FIG. 3G by arrow 364) that may be applied offset from the center of mass of the work vehicle 100 in the longitudinal direction L (e.g., in a direction of the arrow 364). A comparison between FIG. 3C and FIG. 3G shows that the magnitude of the force 360 may be equal or substantially equal to the magnitude of the force 320. Accordingly, the payload displayed by the payload indicator 221 in FIG. 3C may be the same or substantially similar to the payload displayed by the payload indicator 221 in FIG. 3G.

A comparison between FIG. 3C and FIG. 3G also shows that the force 320 and the force 360 act on the work vehicle 100 in different directions. In FIG. 3C, the load weight was distributed equally or substantially equally among each tire of the work vehicle 100. In FIG. 3G, the load weight may be unequally distributed among the tires of the work vehicle 100. For example, the front-left tire and the front-right tire may each carry a larger portion of the load weight in FIG. 3G than in FIG. 3C. The larger portion of the load weight carried by the front-left tire and/or the front-right tire in FIG. 3G may relate to the second component 364 of the force 360. In FIG. 3G, the air pressure displayed by the front-right tire pressure indicator may be greater than the corresponding air pressure displayed in FIG. 3C. A difference between the front-right tire pressure indicator in FIG. 3C and FIG. 3G may be representative of the larger portion of the load weight carried by the front-right tire in FIG. 3G than in FIG. 3C. Although not shown in FIG. 3G, the front-left tire pressure indicator may display an air pressure in FIG. 3G that is the same or substantially similar to the air pressure displayed by the front-right tire pressure indicator in FIG. 3G. In that instance, a difference between the front-left tire pressure indicator in FIG. 3C and FIG. 3G may be representative of the larger portion of the load weight carried by the front-left tire in FIG. 3G.

As another example, the rear-left tire and the rear-right tire may each carry a smaller portion of the load weight in FIG. 3G than in FIG. 3C. The smaller portion of the load weight carried by the rear-left tire and/or the rear-right tire in FIG. 3G may relate to the second component 364 of the force 360. In FIG. 3G, the air pressure displayed by the rear-right tire pressure indicator may be lower than the corresponding air pressure displayed in FIG. 3C. A difference between the rear-right tire pressure indicator in FIG. 3C and FIG. 3G may be representative of the smaller portion of the load weight carried by the rear-right tire in FIG. 3G than in FIG. 3C. Although not shown in FIG. 3G, the rear-left tire pressure indicator may display an air pressure in FIG. 3G that is the same or substantially similar to the air pressure displayed by the rear-right tire pressure indicator in FIG. 3G. In that instance, a difference between the rear-left tire pressure indicator in FIG. 3C and FIG. 3G may be representative of the smaller portion of the load weight carried by the rear-left tire in FIG. 3G.

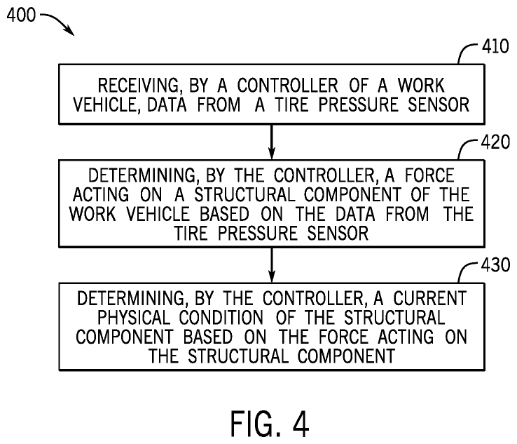

With the foregoing in mind, FIG. 4 is a flow diagram of a method 400 of integrated load condition monitoring for a work vehicle, in accordance with an embodiment of the present disclosure. The method 400 may be performed by the controller 200 described above with reference to FIG. 2 or any other suitable controller(s). Furthermore, the steps of the method 400 may be performed in the order disclosed herein or in any other suitable order. For example, certain steps of the method may be performed concurrently. In addition, in certain embodiments, at least one of the steps of the method 400 may be omitted. In the illustrated embodiment, the method 400 includes receiving, by a controller of a work vehicle, data from a tire pressure sensor, as represented by block 410. For example, the controller 200 of the work vehicle 100 may receive data from one or more tire pressure sensors 170 of the sensor network 210.

Furthermore, the method 400 includes determining, by the controller, a force acting on a structural component of the work vehicle based on the data from the tire pressure sensor, as represented by block 420. For example, the controller 200 may be configured to determine forces acting on one or more structural components of the work vehicle 100 using mathematical models and/or lookup tables stored in the memory 204. The controller 200 may provide data received from one or more of the tire pressure sensors 170 as input to the mathematical models and/or lookup tables stored in the memory 204. The mathematical models and/or lookup tables stored in the memory 204 may output associated forces acting on one or more structural components of the work vehicle 100 responsive to that input. The mathematical models and/or lookup tables stored in the memory 204 may output associated forces acting on one or more structural components of the work vehicle 100 in terms of magnitude and/or direction (e.g., as a vector quantity).

In addition, the method 400 includes determining, by the controller, a current physical condition of the structural component based on the force acting on the structural component, as represented by block 430. For example, the controller 200 may use the determined force acting on the structural component of the work vehicle 100 to determine a current physical condition of the structural component of the work vehicle 100. In certain embodiments, the controller 200 may consider the reference data stored in the memory 204 when determining the current physical condition of the structural component.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. § 112(f).

1. A work vehicle, comprising:
a boom coupled between a work implement and a chassis of the work vehicle;
a sensor network configured to monitor a payload supported by the work implement, wherein the sensor network includes a tire pressure sensor configured to monitor air pressure within a tire of the work vehicle; and
a controller communicatively coupled to the sensor network, wherein the controller is configured to determine a force acting on a structural component of the work vehicle based on air pressure within the tire.

2. The work vehicle of claim 1, wherein the controller is configured to determine that the work vehicle is in an overload state in response to determining the force acting on the structural component is greater than a threshold force.

3. The work vehicle of claim 2, comprising a user interface communicatively coupled to the controller, wherein the controller is configured to control the user interface to present an alert responsive to detecting that the work vehicle is in the overload state.

4. The work vehicle of claim 1, wherein the controller is configured to determine a current physical condition of the structural component based on the force acting on the structural component.

5. The work vehicle of claim 1, wherein the structural component comprises the boom, the chassis, or an axle coupled to the tire.

6. The work vehicle of claim 1, wherein the sensor network comprises a weight sensor configured to monitor a weight carried by the boom.

7. The work vehicle of claim 6, wherein the controller is configured to determine the force based on the weight carried by the boom and the air pressure within the tire.

8. The work vehicle of claim 6, wherein the weight sensor is disposed on the boom between the chassis and the work implement.

9. The work vehicle of claim 1, wherein the work implement comprises a bucket, and the work vehicle comprises a wheel loader.

10. An apparatus comprising:
a sensor network configured to monitor a payload of a work vehicle comprising a first tire and a second tire, wherein the sensor network comprises a first tire pressure sensor configured to monitor air pressure within the first tire and a second tire pressure sensor configured to monitor air pressure within the second tire; and
a controller communicatively coupled to the sensor network, wherein the controller is configured to determine a force acting on a structural component of the work vehicle based on the air pressure within the first tire and the air pressure within the second tire.

11. The apparatus of claim 10, wherein the force comprises a magnitude and a direction.

12. The apparatus of claim 10, wherein the controller is configured to determine a weight of material within a volume of a work implement coupled to a boom of the work vehicle based on the air pressure within the first tire and the air pressure within the second tire.

13. The apparatus of claim 10, wherein the first tire and the second tire are coupled to different axles of the work vehicle, and the controller is configured to determine that the work vehicle is in an overload state in response to determining that a difference between the air pressure within the first tire and the air pressure within the second tire exceeds a threshold value.

14. The apparatus of claim 11, wherein an axle of the work vehicle is coupled between the first tire and the second tire, and the control system is configured to determine a weight distribution at a work implement coupled to a boom of the work vehicle based on the direction of the force.

15. The apparatus of claim 10, wherein the control system is configured to determine a remaining service life of the structural component based on the force.

16. A method comprising:
receiving, by a controller of a work vehicle, data from a tire pressure sensor configured to monitor air pressure within a tire of the work vehicle;
determining, by the controller, a force acting on a structural component of the work vehicle based on the data from the tire pressure sensor; and
determining, by the controller, a current physical condition of the structural component based on the force acting on the structural component.

17. The method of claim 16, comprising:
outputting, by a communication interface of the work vehicle, vehicle state data to a remote computing device, wherein the vehicle state data comprises the current physical condition of the structural component.

18. The method of claim 16, comprising:
determining, by the controller, a weight of material within a volume of a work implement coupled to a boom of the work vehicle based on the data from the tire pressure sensor.

19. The method of claim 18, comprising:
outputting, by a communication interface of the work vehicle, a notification to a remote computing device in response to a payload of the work vehicle exceeding a threshold value, wherein the payload comprises the weight of material.

20. The method of claim 16, comprising:
determining, by the controller, a weight distribution at a work implement coupled to a boom of the work vehicle based on the data from the tire pressure sensor.
